(19) United States
(12) Patent Application Publication
(10) Pub. No.: US 2005/0015337 A1
(43) Pub. Date: Jan. 20, 2005

(54) Address billing system

(76) Inventor: Keith Anthony Washington, Oakland, CA (US)

Correspondence Address: Keith Anthony Washington, 2101 10th Avenue, Oakland, CA, 94606, US

(21) Appl. No.: 10/632,323

(22) Filed: Sep. 27, 2004

Related U.S. Application Data
(62) Division of application No. 10/246,187, filed on Sep. 17, 2002, now abandoned.

(51) Int. Cl. G06F 17/60

(52) U.S. Cl. 705/40

(57) ABSTRACT

A anti-fraud billing system, that is of the utmost simplicity ease of use. A credit card system that uses a person's mailing address and telephone number for its numbers. And uses a value customer date for its numbers, all to prevent misuse of the credit card billing system.

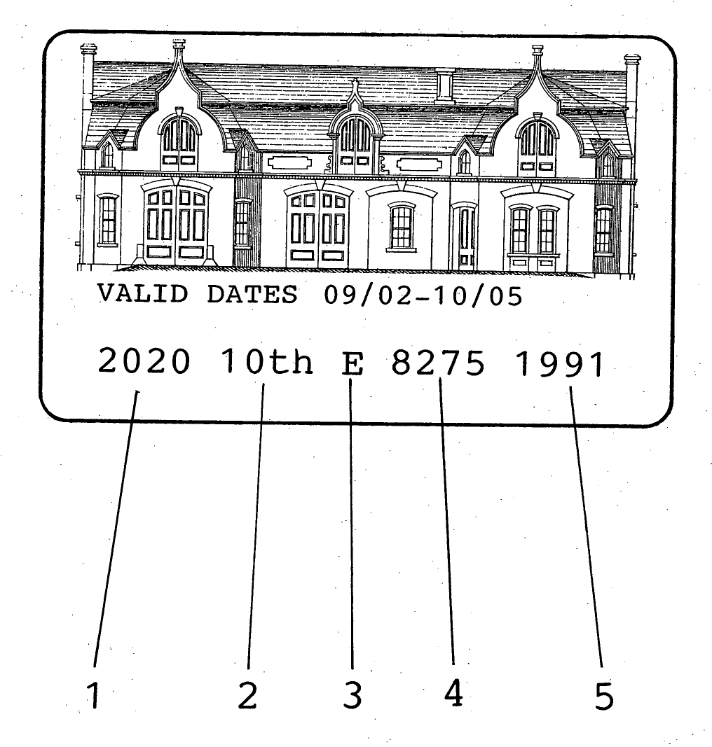

### BACKGROUND OF THE INVENTION

This invention relates to a anti-fraud billing system that uses one's address and telephone number for its numbers.

### BACKGROUND—DESCRIPTION OF PRIOR ART

Banks and credit card issuers commonly supply consumers with credit cards. Cards to be used at home, on the phone or on-line and in the mail. As more people use thier cards more and more credit card numbers are being stolen.

Thereafter, inventors have tried to create fraud proof credit cards. U.S. Pat. No. 5,259,649 to shomron (1993) discloses a complex credit card, which can prevent fraud on telephone orders only. However the problems with credit card fraud is far greater than what this card covers.

A perfect example of todays credit card problems. Two 18-year-old british men were arrested by the FBI, after stealing millions of dollars worth of credit card numbers. the men allegedly hacked into a e-commerce web-site, a toltal of nine sites were hit by the hackers. The FBI said the theft involved credit card information from more that 26,000 accounts. Losses could exceed 3 million authorities said. Most credit card customers find themselves less in danger from credit card theft as card issuers cap fraudulent charges at $50. Merchants however have no such protection if stolen card numbers are used to purchase goods.

According to a recent survey by the computer security institute, 273 businesses reported over a quarter-billion dollars in losses related to computer hacking in the year 2002. The U.S. Pat. No. 5,259,649 to shomron (1993) cannot prevent any of the obove problems from occurring. Furthermore, this card is not fraud proof. The only protection this card has, is when it is lost or stolen. If it is lost or stolen, you won't know which numbers to use. But when it is used on the phone or on-line, etc, you can see the right numbers to commit fraud. This card is only creating a false sence of security.

### OBJECTS AND ADVANTAGES

Accordingly, several objects and advantages of the present invention are:

(a) A credit card system that can be kept in plain view, without worry of it being stolen.

(b) A credit card system that will allow merchants to safely ship thousands of dollars in merchandise with confidence.

(c) A credit card system that merchants will not have any fraudulent charge backs with.

(d) A credit card system that has numbers that cannot be stolen.

(e) A credit card system that will make people feel good and safe, about shopping at home.

(f) A credit card system that is 100 percent fraud proof.

(g) A credit card system that protects the bank, the customer and the merchant.

Further abjects and advantages are to provide the merchant with valuable information. The Address Billing System can do so just by looking at it's numbers. Such as, it verifies a person's mailing address, it verifies a person's telephone number. The value customer date can protect a merchant against identity theft credit cards.

### BRIEF SUMMARY OF THE INVENTION

A credit card system that is of the utmost simplicity, ease of use and mimimum cost to make, while at the same time being highly effective in preventing misuse of the system. The numbers from the system are a built in security feature. When this system is used on-line or on the telephone, and in the mail, the merchant will know right away if someone is trying to commit fraud. This system uses a person's address and telephone number for its numbers.

### BRIEF DESCRIPTION OF THE DRAWING

The invention is illustrated with reference to the enclosed billing system, drawing in which:

The address credit card shows five of its features in one view numbered one through five. 1 Shows a person's address, this number twenty twenty will be matched up with a person's shipping address by the merchant. The second number tenth 2 will also be matched for the person's street address. If a person lives in a apartment building the merchant will translate this letter 3 into a number. In this case the E is translated into the number 5 for the fifth letter of the alphabet. 4 Is the last four digits of a person's telephone number. The merchant will use caller ID and match the digits for non-tangible services. 5 Is a value customer date, showing the merchant how long a person has done business with the bank. This will show the merchant if it is a possible identity theft case.

### DETAILED DESCRIPTION OF THE INVENTION

A credit card system that is of the utmost simplicity, ease of use and ninimum cost; while at the same time being highly effective in preventing misuse of the system. This system has a built-in security feature, when the system is used on-line or on the telephone, the merchant will know right away if someone is trying to commit fraud. The numbers from the system are what makes the system unique and fraud proof. If the first digits from the system are twenty twenty 1 ten 2 after I give the systems complete number, and the merchant asks me for my mailing address. I then tell him or her that my mailing address is: twenty twenty tenth avenue. The merchant will then match the address with the systems numbers, to see if they are a perfect match. If I told them, for instance, my address was fifty fifty nineteenth ave. they would immediately know that this is a fraudulent activity.

If a person lives in a multi-unit apartment building, it will work the same way. If a person's address is: ten ten oakdale drive apartment #16: the first 6 digits will look like this 1010 16. If a person lives in a building with letters only, let's say the letter E 3 is on the door. The numbers would look like this 1010 5. The fifth number would be a five for the fifth letter of the alphabet. If a person is buying a product with a mail order form, when it is received by the merchant he or she can clearly see and determine if it is fraudulent activity. My address and system numbers will be exactly the same.

The system also uses the last four digits of a person's telephone number 4. This will stop credit card fraud on non-tangible purchases. Such as newspaper ads and internet services. And this number can also be used to have a package drop-shipped. The merchant will use a caller ID system, if the last four digits of the person's telephone number doesn't match the systems numbers the merchant will know it is a fraudulent activity. Banks will also have the option of using the last four digits as a valued customer date 5. This date will show the merchant how long a person has done business with a particular bank.

1. An anti-fraud billing system, a billing process which bills the actual numbers, and or letters, of a person's shipping address, after a person's shipping numbers are entered into the systems data base they will then be used to wire that person money, the numbers from the system will then be matched to the person's shipping address for verification of ownership of the systems numbers, if letters are used in the system the merchant will translate the letters into numbers, such as, the letter e will translate into the number 5 for the fifth letter of the alphabet.

2. An anti-fraud billing system, a system which is made up from the actual numbers of a person's telephone number, the telephone number will be entered into the systems data base to wire that person money, the data base uses a person's telephone number for its billing numbers to be used on telephone orders, the merchant will use a caller id system to match the numbers for verification of ownership.

3. An anti-fraud billing system, a system that uses a value customer date for its numbers, informing the merchant of the date the systems data base was created, such as, if the data base numbers read 1982 the merchant will know the systems data base was created and issued in the year of 1982.
